(19) United States
(12) Patent Application Publication
(10) Pub. No.: US 2007/0144010 A1
(43) Pub. Date: Jun. 28, 2007

(54) METHOD OF MANUFACTURING DYNAMIC PRESSURE BEARING MEMBER

(75) Inventors: Hiroshi Sato, Chiba (JP); Yuji Shishido, Kanagawa (JP); Takeshi Kaneko, Chiba (JP); Kenichiro Yazawa, Tokyo (JP); Yoshiaki Kakinuma, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/613,026

(22) Filed: Dec. 19, 2006

(30) Foreign Application Priority Data
Dec. 22, 2005 (JP) P2005-370684

(51) Int. Cl. H02K 5/16; H02K 15/00

(52) U.S. Cl. 29/898; 310/90; 29/596

(57) ABSTRACT

A method of manufacturing dynamic pressure bearing member is provided. A method of manufacturing a dynamic pressure bearing member, by providing a metal mold die including a core pin provided with protruding stripes of a predetermined shape formed on an outer peripheral surface for forming dynamic pressure grooves, and injecting molten resin in the metal mold die to form at least a series of dynamic pressure grooves on an inner peripheral surface with a circular cross-section in an inner circumferential direction, includes the step of pulling out in a forced pullout manner one of the core pin from the dynamic pressure bearing member or the dynamic pressure bearing member from the core pin in an axial direction of the dynamic pressure bearing member after curing the molten resin, in a condition in which a free space is provided around an outer periphery of the molded dynamic pressure bearing member.

### CROSS REFERENCES TO RELATED APPLICATIONS

The present application claims priority to Japanese Patent Application JP b 2005-370684 filed in the Japan Patent Office on Dec. 22, 2005, the entire contents of which being incorporated herein by reference.

### BACKGROUND

The present application relates to improvement of a method of manufacturing a dynamic pressure bearing member, which has a radial bearing surface provided with dynamic pressure grooves formed on a cylindrical inner peripheral surface thereof and is particularly suitable for a dynamic pressure bearing for small motors.

First, a dynamic pressure bearing member, a metal mold die therefor, and a manufacturing method thereof in the related art will now be explained with reference to the drawings.

FIGS. 12A and 12B show a first example of a core pin used for forming the dynamic pressure bearing member of the related art by injection molding, wherein FIG. 12A is a side view thereof, and FIG. 12B is an enlarged cross-sectional view. FIGS. 13A and 13B show a first example of the dynamic pressure bearing member of the related art formed by the injection molding using the core pin shown in FIGS. 12A and 12B, wherein FIG. 13A is a side cross-sectional view, and FIG. 13B is an enlarged cross-sectional view of a substantial part thereof. FIG. 14 is a cross-sectional view of a substantial part of an example of an injection molding die for injection-molding the dynamic pressure bearing member of the related art. FIG. 15 is a cross-sectional view of a part of the injection molding die and the dynamic pressure bearing member shown in FIG. 14 for explaining a demolding process of the molded dynamic pressure bearing member of the related art. FIG. 16 is an enlarged cross-sectional view of a substantial part of a second example of the core pin of the related art. FIG. 17 is an enlarged cross-sectional view of a substantial part of a second example of the dynamic pressure bearing member formed by the injection molding using the core pin shown in FIG. 16.

As a small motor used ordinarily in precision electronic equipment, there is cited a motor having a rotary shaft supported in a noncontact manner with a dynamic pressure bearing made of synthetic resin. In the dynamic pressure bearing of this type, there is used a dynamic pressure bearing member having a radial bearing surface formed by providing dynamic pressure grooves of a predetermined shape on the inner peripheral surface of the cylindrical opening in which the rotary shaft of the motor is inserted.

Such a dynamic pressure bearing member made of synthetic resin according to the related art is formed by molding, using the core pin having pin grooves formed thereon with a shape corresponding to the shape of the dynamic pressure grooves on the radial bearing surface and a predetermined metal mold die for forming the shape of the outer periphery of the dynamic pressure bearing member, and injecting the molten synthetic resin between the both members. It is arranged that, during that process, the radial dynamic pressure grooves can simultaneously be formed on the inner peripheral surface of the cylindrical opening. The depth of the dynamic pressure grooves, which varies in accordance the shaft diameter, the bearing gap, and the used dynamic pressure fluid, is typically in a range of about 2 through 12 μm. After curing the molten synthetic resin thus injected, the molded object is demolded from the metal mold die, thus the dynamic pressure bearing member provided with the dynamic pressure grooves having a predetermined shape and size can be obtained.

In the method of manufacturing the dynamic pressure bearing member of the related art described above, the dynamic pressure bearing member is formed by injection molding forming the dynamic pressure grooves on the inner peripheral surface of the cylindrical opening thereof. Therefore, when the dynamic pressure bearing member thus molded and cured is demolded from the core pin, it is pushed out in the axial direction thereof, which inevitably causes the dynamic pressure grooves to be pulled out in a forced pullout manner.

If it is pulled out in a forced pullout manner without any changes, the following problems arise.

1. There are caused deformation of the dynamic pressure grooves and scratches on the inner peripheral surface (the radial bearing surface) of the dynamic pressure bearing member provided with the dynamic pressure grooves.

2. Further, since demolding of the dynamic pressure grooves by the forced pullout causes the demolding pressure to become strong, a part of the dynamic pressure bearing member pushed while demolding might be deformed.

3. In particular, a high rigidity material needs to be used for achieving the dimensional accuracy required for the dynamic pressure bearing and the rigidity required for the dynamic pressure bearing member, and the higher the rigidity of the material is, the more difficult the forced pullout becomes.

Therefore, as an example of a solution of the aforementioned problems, JP-A-2001-65570 (pages 3 and 4, FIGS. 1 through 4, hereinafter referred to as Patent Document 1) discloses a dynamic pressure bearing member and a manufacturing method thereof, declared to be molded with high dimensional accuracy to offer the bearing performance without any deformations or scratches caused by the forced pullout even if the dynamic pressure bearing member is formed by injection molding using a material with the coefficient of elasticity no smaller than 6 GPa, which satisfies the dimensional accuracy required for the dynamic pressure bearing member and the rigidity required for the dynamic pressure bearing member, and then pulled out in a forced pullout manner.

These technologies will hereinafter be described reattaching the drawings attached to Patent Document 1, as FIGS. 12 through 17.

FIG. 12A is a side view of a core pin 9A of a first example, wherein the core pin 9A is provided with a radial dynamic pressure bearing forming section 9b on the outer peripheral surface thereof configured by serially forming protruding stripes, namely V-shape land sections where pin grooves Mr for a radial dynamic pressure grooves are formed between the land sections L. In the case of the core pin 9A shown in FIG. 12A, the radial dynamic pressure bearing forming sections 9b are formed in two columns in parallel with each other along the axial direction thereof.

FIG. 12B is an enlarged cross-sectional view showing the pin grooves Mr and corresponding land sections L. In the dynamic pressure bearing member 20A (FIGS. 13A, 13B) of the first example as a molded product, the pin grooves Mr (concave portions) of the core pin 9A generate dynamic pressure groove land sections (convex portions) 22, and on the contrary, the land sections L (convex portions) of the core pin 9A generate dynamic pressure grooves 21 (concave portions).

As shown in the enlarged view of FIG. 12B, the edge sections of the pin grooves Mr of the core pin 9A are processed to be substantially round corners. It is asserted that, by thus processing the edge sections E of the pin grooves Mr for the dynamic pressure grooves to be substantially round corners, the demolding pressure applied when demolding the dynamic pressure bearing member 20A (FIGS. 13A, 13B) as an injection-molded object from the metal mold diein the injection molding process is lowered, it can be molded with high dimensional accuracy without any deformations of the dynamic pressure grooves 21 of the dynamic pressure bearing member 20A nor scratches in the radial bearing surface 20n including the dynamic pressure grooves 21. Further, it is asserted that demolding can smoothly be performed and no deformation is caused by excessive pressure in the portion (a flange section 20F in the dynamic pressure bearing member 20A) directly pushed by, for example, an ejector pin 11 (FIG. 14).

FIGS. 13A and 13B show the resin dynamic pressure bearing member 20A thus formed by injection molding as the first example. The dynamic pressure bearing member 20A is what is formed by injection molding using an injection molding device described later with reference to FIG. 14 and the core pin 9A shown in FIGS. 12A and 12B, which is a dynamic pressure bearing member made of resin for both radial and thrust directions provided with a radial dynamic pressure section R having the radial dynamic pressure grooves 21 (concave sections) and the land sections (convex sections) 22 on the inner peripheral surface 20n of the cylindrical section 20a by serially forming around the inner surface 20n in the axial direction in two columns in parallel to each other as V-shaped grooves, and a thrust bearing section S in a bottom surface 20b continuing therefrom. The inner peripheral surface 20n of the cylindrical section is provided with the shape of the core pin 9A transferred thereto, wherein the pin groove Mr of the core pin 9A for the radial dynamic groove generates the land section (convex section) 22 in the dynamic pressure bearing member 20A, and the land section L of the core pin 9A generates the dynamic pressure groove 21 in the dynamic pressure bearing member 20A. It should be noted that a flange section 20F is provided to the outer peripheral section as shown in the drawing.

As described above, since the edge sections E of the pin grooves Mr of the core pin 9A are chamfered to be substantially round corners, groove bottom corners 21e of the dynamic pressure grooves 21 are processed to be substantially round corners in the dynamic pressure bearing member 20A, other portions than the dynamic pressure grooves 21 are also processed as concave sections 23 with depths substantially the same as the dynamic pressure grooves 21. In the actual use, the concave sections 23 other than the dynamic pressure grooves 21 function as lubricating oil basins.

The processing amount of the substantially round corners in the dynamic pressure bearing member 20A is set to be 5 through 40% of the depth of the dynamic pressure grooves 21. It is asserted that deformation or scratches are caused in the land section 22 when demolding the molded dynamic pressure bearing member 20A if it is smaller than 5%. Further, it is asserted that although the larger the processing amount of the round corners is, the better for preventing the deformation or the scratches in demolding, if it exceeds 40%, the performance as the dynamic pressure bearing is degraded, and accordingly, the upper limit thereof is set to 40%.

Further, Patent Document 1 also discloses an injection molding die for molding the dynamic pressure bearing member 20A by injection molding. FIG. 14 shows the injection molding die in the related art, and the manufacturing method of the dynamic pressure bearing member in the related art will be explained with reference to FIG. 15.

This injection molding die is a pin-point gate type metal mold die composed of three plates configured including a fixed part die 5, a movable part die 8, and the core pin 9.

The fixed part is mainly composed of a spool bushing 1 including a spool la, a fixed part mounting plate 3 with a runner lock pin 2 attached thereto, a runner stripper plate 4, the fixed part die 5, a fixed part die holder 6, and so on, wherein the fixed part die 5 is provided with a runner 5a, a gate 5b, and a planar parting surface 5c formed thereon. It should be noted that the parting surface 5c can be provided with a cavity formed thereon, which can form a part of the bottom surface 20b of the cylindrical section with the thrust bearing section S of the dynamic pressure bearing formed thereon.

The movable part is mainly composed of the movable part die 8 with a movable part cavity 7, the core pin 9, an ejector pin 11, and so on, wherein the cavity 7 of the movable part die 8 is provided with a flange section cavity 7a to form the flange section 20F of the dynamic pressure bearing member 20A and a cylindrical section cavity 7b to form the cylindrical section 20a formed therein. This movable part die 8 is provided with a planar parting surface 7c capable of adhering to the parting surface 5c of the fixed part die 5 formed thereon. The movable part die 8 is further held by a movable part die holder 10. Specifically, the movable part die 8 is held so that the parting surface 7c thereof forms the same plane as the parting surface 8a of the movable part die holder 10.

The core pin 9 is inserted in the cylindrical section cavity 7b of cavity 7 of the movable part die 8 in a concentric manner, and the end face of the core pin 9, which is the thrust bearing forming section 9a as described above, is formed to have a shape of a partial spherical concave section in this example. On the outer peripheral surface continuing thereto, there is formed the radial dynamic pressure bearing forming section 9b to form the dynamic pressure grooves 21 for generating the dynamic pressure.

The ejector pin 11 is built-in so as to be able to press the flange section 20F of the dynamic pressure bearing member 20A.

It should be noted that other die components (e.g., a guide pin, a support pin, a spacer block, a movable part mounting plate, an ejector plate attached with the ejector pin, a return pin, a spring, and so on) in the movable part, a tension link for operating the three plates, a puller bolt, a stop bolt, a die temperature control heater, and so on are omitted from the drawings.

In the case in which the dynamic pressure bearing member 20A as the bearing member is formed by injection molding using the injection molding die with the configuration described above, molten resin is injected in the injection molding die from an injection nozzle of the injection molding machine not shown, and the injected molten resin flows into the cavity 7 of the movable part die 8 from the single pin-point gate 5b provided substantially the center of the fixed part die 5 through the spool 1a and the runner 5a, and is sequentially filled in the cylindrical section cavity 7b after evenly filled in the flange section cavity 7a of the cavity 7 of the movable part die 8.

Subsequently, after being cooled while maintaining the pressure, as shown in FIG. 15, the movable part die 8 recedes from the fixed part die 5 in accordance with opening of the injection molding machine to separate the parting surface 5c and the parting surface 8a, and at the same time, the core pin 9 is demolded from the inside of the molded dynamic pressure bearing member 20A in a forced pullout manner. It should be noted that in this case the ejector pin 11 continues to push the flange section 20F of the dynamic pressure bearing member 20A.

Subsequently, the ejector pin 11, which has continued to push the flange section 20F of the dynamic pressure bearing member 20A, is moved backward and the dynamic pressure bearing member 20A is scratched down from the parting surface 5c of the fixed part die 5 by a wiper not shown or the like, thus the gate section 5b is broken away to obtain the dynamic pressure bearing member 20A shown in FIG. 13A as a product.

Subsequently, a space is created between the fixed part die 5 and the runner stripper plate 4 and between the runner stripper plate 4 and the fixed part mounting plate 3 by the tension link, the puller bolt, and the stop bolt not shown.

It should be noted that the position at which the ejector pin 11 pokes out the molded object is not limited to the surface of the flange section 20F, but the end face of the opening of the dynamic pressure bearing member 20A as the molded object can be poked to eject it.

However, as described above, in the molding method of the dynamic pressure grooves 21 onto the inner peripheral surface of the dynamic pressure bearing member in the related art, the resin with certain elasticity is injected inside the cavity of the metal mold die with the core pin 9 inserted thereto, and then forced pullout is performed. Since the straight sections H of the core pin 9A and the straight sections J of the dynamic pressure grooves 21 in the dynamic pressure bearing member 20A corresponding thereto facing perpendicular to the forced pullout force X as shown in FIGS. 12A and 12B cause resisting force, the forced pullout force X needs to be set greater. Further, since unnecessary force acts on the dynamic pressure bearing member 20A, there is a problem that scratches are easily caused.

Further, as the core pin 9B, which can more preferably be pulled out in a forced pullout manner than the dynamic pressure bearing member 20A in the first example, it is asserted that by having processed the bottom corner sections 9c of the pin grooves Mr of the radial dynamic pressure grooves and the land sections L thereof to be substantially round corners as shown in FIG. 16, both of each of the bottom corners 21e of each of the dynamic pressure grooves 21 of the injection-molded dynamic pressure bearing member 20B and the edges 22E of each of the land sections 22 can be processed to be substantially round corners, thus the dynamic pressure bearing member 20B having each of the bottom corners 21e of each of the dynamic pressure grooves 21 and the edges 22E of each of the land sections (convex sections) 22 processed to be substantially round corners can be obtained as shown in FIG. 17, and since each of the bottom corners 21e of each of the dynamic pressure grooves 21 and the edges 22E of each of the land sections (convex sections) 22 are formed to be substantially round corners, the dynamic pressure bearing member 20B of the second example can more preferably be pulled out from the injection molding die in a forced pullout manner than the dynamic pressure bearing member 20A in the first example.

However, even in such a dynamic pressure member 20B, since there still exist the straight sections H in the land sections L of the core pin 9B and the straight sections J in the dynamic pressure grooves 21 of the dynamic pressure bearing member 20B, both facing each other perpendicular to the forced pullout force X causing resisting force, the forced pullout force X must be set greater, further since unnecessary force acts on the dynamic pressure bearing member 20B, there is also the problem that scratches are easily caused.

### SUMMARY

Thus, there is a need for providing a method of manufacturing the dynamic pressure bearing member capable of easily pulling out the dynamic pressure bearing member from a metal mold die in a forced pullout manner even with small forced pullout force and without scratching predetermined grooves formed on an inner peripheral surface.

Therefore, according to an embodiment, there is provided a method of manufacturing a dynamic pressure bearing member by providing a metal mold die including a core pin provided with protruding stripes of a predetermined shape formed on an outer peripheral surface for forming dynamic pressure grooves, and injecting molten resin in the metal mold die to form at least a series of dynamic pressure grooves on an inner peripheral surface with a circular cross-section in an inner circumferential direction, including the step of pulling out in a forced pullout manner one of the core pin from the dynamic pressure bearing member or the dynamic pressure bearing member from the core pin in an axial direction of the dynamic pressure bearing member after curing the molten resin, in a condition in which a free space is provided around an outer periphery of the molded dynamic pressure bearing member.

Further, according to another embodiment, there is provided a method of manufacturing a dynamic pressure bearing member provided with at least a series of dynamic pressure grooves formed on an inner peripheral surface with a circular cross-section in the inner circumferential direction by injection molding, including the steps of providing an injection molding die including a fixed part die provided with a molten resin injection gate formed adjacent to a parting surface, a movable part die provided with a parting surface capable of adhering to the parting surface of the fixed part die, a through hole with a circular cross-section penetrating to the parting surface, and a cavity forming at least a part of the dynamic pressure bearing member to be formed, a core pin having a thickness capable of being inserted in the through hole of the movable part die, facing at least the cavity, and provided with protruding stripes of predetermined shapes formed on the outer peripheral surface, for forming the dynamic pressure grooves, fastening the parting surface of the movable part die to the parting surface of the fixed part die after abutting the parting surface of the movable part die on the parting surface of the fixed part die and adhering the parting surface of the movable part die to the parting surface of the fixed part die in the condition in which the core pin is inserted to a predetermined position of the through hole of the movable part die, filling the cavity formed of the fixed part die and the movable part die with the molten resin by injecting the molten resin into the cavity from the molten resin injection gate, releasing the fastening between the fixed part die and the movable part die after the injected and filled molten resin has been cured, moving the movable part die backward from the parting surface of the fixed part die and an outer peripheral surface of the cured dynamic pressure bearing member, subsequently pulling out in a forced pullout manner one of the core pin from the dynamic pressure bearing member or the dynamic pressure bearing member from the core pin in an axial direction of the dynamic pressure bearing member, in a condition in which the movable part die does not exist around the dynamic pressure bearing member.

Further, in the method of manufacturing a dynamic pressure bearing member according to another embodiment, it is preferable that the protruding stripes on the outer peripheral surface of the core pin are formed in two or more columns with a predetermined interval in the axial direction of the core pin.

Further, in the method of manufacturing a dynamic pressure bearing member according to another embodiment, it is preferable that the protruding stripes on the outer peripheral surface of the core pin are V-shaped protrusions provided in series.

Further, in the method of manufacturing a dynamic pressure bearing member according to another embodiment, it is preferable that the core pin is rotated, and the core pin is pulled out in a forced pullout manner in the axial direction of the dynamic pressure bearing member in the condition in which the free space is provided around the dynamic pressure bearing member.

Further, in the method of manufacturing a dynamic pressure bearing member according to another embodiment, it is preferable that the rotational direction of the core pin is a direction towards the extremity of the V-shaped protruding stripes.

Further, in the method of manufacturing a dynamic pressure bearing member according to another embodiment, it is preferable that in the case in which the core pin is pulled out in a forced pullout manner in the axial direction of the dynamic pressure bearing member provided with the dynamic pressure grooves formed on the inner peripheral surface of the cylindrical section in two or more columns, the rotational angle of the core pin excludes an angle with which the series of protruding stripes drop in the adjacent dynamic pressure grooves in the axial direction in which the core pin is pulled out in a forced pullout manner.

Further, in the method of manufacturing a dynamic pressure bearing member according to another embodiment, it is preferable that corners of the protruding stripes formed on the outer peripheral surface of the core pin are chamfered.

Further, in the method of manufacturing a dynamic pressure bearing member according to another embodiment, it is preferable that the protruding stripes are formed so that a shape of a cross-section of each of the protruding stripes formed on the outer peripheral surface of the core pin forms an acute angle with the reference of the outer peripheral surface of the core pin to a direction of the forced pullout of the dynamic pressure bearing member, and the acute angle is in a range of 30° through 45°.

Further, in the method of manufacturing a dynamic pressure bearing member according to another embodiment, it is preferable that the cross-sectional shapes corresponding to the shapes of the dynamic pressure grooves are formed on the outer peripheral surface of the core pin as trapezoidal protruding stripes, a tilt angle of at least a rear slope of the trapezoidal protruding stripes in the forced pullout direction is formed as an acute angle with the reference of the outer peripheral surface of the core pin, the acute angle is formed in a range of 30° through 45°, and the surface corner sections of each of the trapezoidal protruding stripes and the base sections of each of the trapezoidal protruding stripes are chamfered or formed as substantially round corners.

Further, in the method of manufacturing a dynamic pressure bearing member according to another embodiment, it is preferable that the cross-sectional shapes corresponding to the shapes of the dynamic pressure grooves are formed on the outer peripheral surface of the core pin as partial circular protruding stripes, the base sections of each of the partial circular protruding stripes are chamfered or formed as substantially round corners.

Further, in the method of manufacturing a dynamic pressure bearing member according to another embodiment, it is preferable that the protruding stripes of the core pin are configured by forming V-shaped protrusions on the outer peripheral surface thereof in series.

Therefore, according to the method of manufacturing a dynamic pressure bearing member of an embodiment, when the dynamic pressure bearing member is demolded from the movable part die after injection-molded, the dynamic pressure bearing member is pulled out from the core pin in a forced pullout manner or the core pin is pulled out from the dynamic pressure bearing member in a forced pullout manner. In this case, since a free space is provided on the outer peripheral surface of the dynamic pressure bearing member, the dynamic pressure bearing member is expanded towards the outside, and further, since the holding power is weaker in comparison with the case with the manufacturing method of a dynamic pressure bearing member in the related art, the required forced pullout force can be reduced, thus the dynamic pressure bearing member can be pulled out from the core pin without applying unnecessary force.

Further, by chamfering the edges of the protruding stripes formed on the outer peripheral surface of the core pin, by forming them as substantially round corners, or by providing them with slopes such as a trapezoidal or circular shape, the dynamic pressure bearing member can be pulled out from the core pin in a forced pullout manner with much weaker force.

According to the method of manufacturing a dynamic pressure bearing member of an embodiment, a number of benefits can be realized. For example, it can be prevented that the dynamic pressure bearing member is easily scratched during the forced pullout process. Further, the forced pullout force can be weakened to increase freedom of injection molding machines. The forced pullout force can also be weakened to ease the limitation in elasticity of resins used as the dynamic pressure bearing member, thus enhancing freedom of selection of the resin.

Additional features and advantages are described herein, and will be apparent from, the following Detailed Description and the figures.

### BRIEF DESCRIPTION OF THE FIGURES

FIG. 1 is a cross-sectional view of an example of an injection molding die composed of a fixed part die and a movable part die for injection-molding the dynamic pressure bearing member according to an embodiment and shown in a condition in which the both are fastened to each other.

FIG. 2 is a cross-sectional view showing a condition in which the injection molding die shown in FIG. 1 is opened.

FIG. 3 is a cross-sectional view showing a condition in which the cured dynamic pressure bearing member is demolded from a parting surface of the fixed part die, and shows an action following the action shown in FIG. 2.

FIG. 4 is a cross-sectional view showing a moment at which a core pin of the movable part die and the dynamic pressure bearing member are separated from each other in a forced pullout manner, and shows an action following the action shown in FIG. 3.

FIG. 5 is a cross-sectional view showing a condition in which the core pin of the movable part die and the dynamic pressure bearing member are completely separated from each other in a forced pullout manner, and shows an action following the action shown in FIG. 4.

FIG. 6 is a cross-sectional view showing the relationship between the dynamic pressure bearing member in the condition of being obtained by the method of manufacturing a dynamic pressure bearing member according to an embodiment and the injection molding die, and shows an action following FIG. 5.

FIGS. 7A and 7B are explanatory views of the case of pulling out the core pin in a forced pullout manner only in the axial direction of the dynamic pressure bearing member, wherein FIG. 7A is a development of radial dynamic pressure grooves formed on the inner peripheral surface of the dynamic pressure bearing member, and FIG. 7B is a development obtained by overlapping a development of protruding stripes formed on the outer peripheral surface of the core pin with the development of the radial dynamic pressure grooves of FIG. 7A.

FIGS. 8A and 8B are explanatory views of the case of pulling out the core pin in a forced pullout manner in the axial direction of the dynamic pressure bearing member while slightly rotating the core pin, wherein FIG. 8A is the development of radial dynamic pressure grooves formed on the inner peripheral surface of the dynamic pressure bearing member, and FIG. 8B is the development obtained by overlapping the development of protruding stripes formed on the outer peripheral surface of the core pin with the development of the radial dynamic pressure grooves of FIG. 8A.

FIG. 9 is a cross-sectional view showing a part of the core pin with a first shape preferably used for an embodiment and a part of the dynamic pressure bearing member with a first shape molded with the present core pin.

FIG. 10 is a cross-sectional view showing a part of the core pin with a second shape preferably used for an embodiment and a part of the dynamic pressure bearing member with a second shape molded with the present core pin.

FIG. 11 is a cross-sectional view showing a part of the core pin with a third shape preferably used for an embodiment and a part of the dynamic pressure bearing member with a third shape molded with the present core pin.

FIGS. 12A and 12B show a first example of the core pin used in the case of injection-molding the dynamic pressure bearing member in the related art, wherein FIG. 12A is a side view thereof, and FIG. 12B is an enlarged cross-sectional view of a substantial part thereof.

FIGS. 13A and 13B show a first example of the dynamic pressure bearing member of the related art injection-molded using the core pin shown in FIGS. 12A and 12B, wherein FIG. 13A is a side view thereof, and FIG. 13B is an enlarged cross-sectional view of a substantial part thereof.

FIG. 14 is a cross-sectional view showing a substantial part of an example of the injection molding die for injection-molding the dynamic pressure bearing member of the related art.

FIG. 15 is a cross-sectional view of a part of the injection molding die and the dynamic pressure bearing member shown in FIG. 14 for explaining the demolding process of the molded dynamic pressure bearing member of the related art.

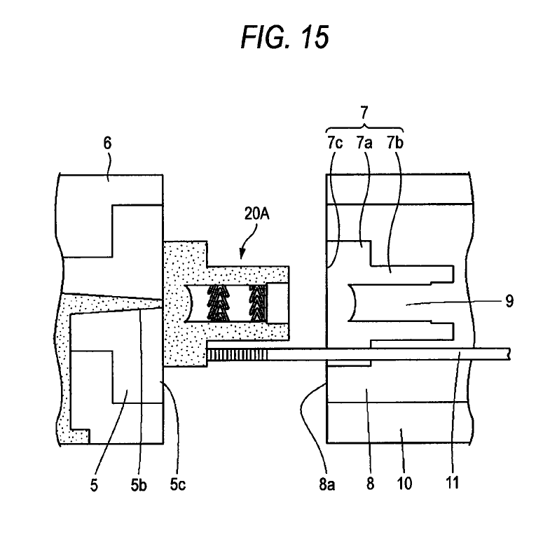

FIG. 16 is an enlarged cross-sectional view of a substantial part of a second example of the core pin of the related art.

FIG. 17 is an enlarged cross-sectional view of a substantial part of a second example of the dynamic pressure bearing member injection-molded using the core pin of FIG. 16.

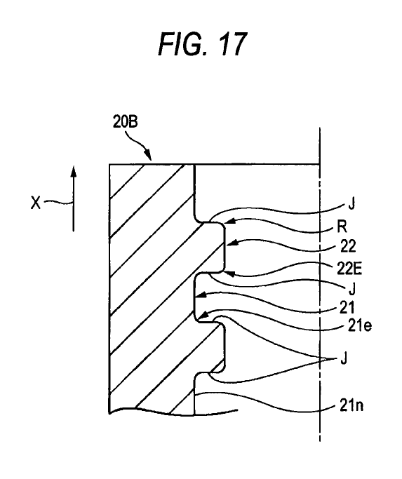

### DETAILED DESCRIPTION

A method of manufacturing a dynamic pressure bearing member according to an embodiment will hereinafter be explained with reference to the accompanying drawings.

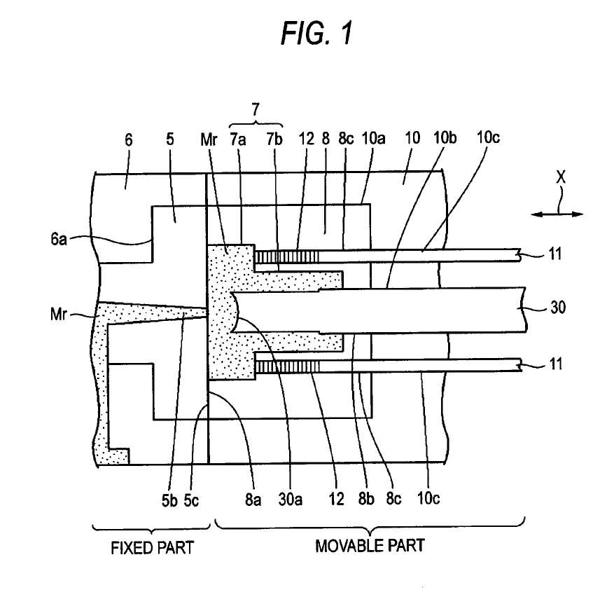

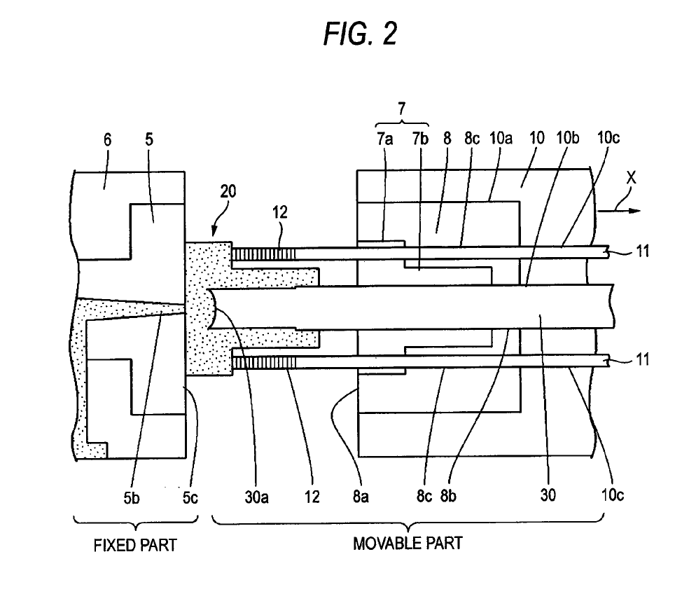

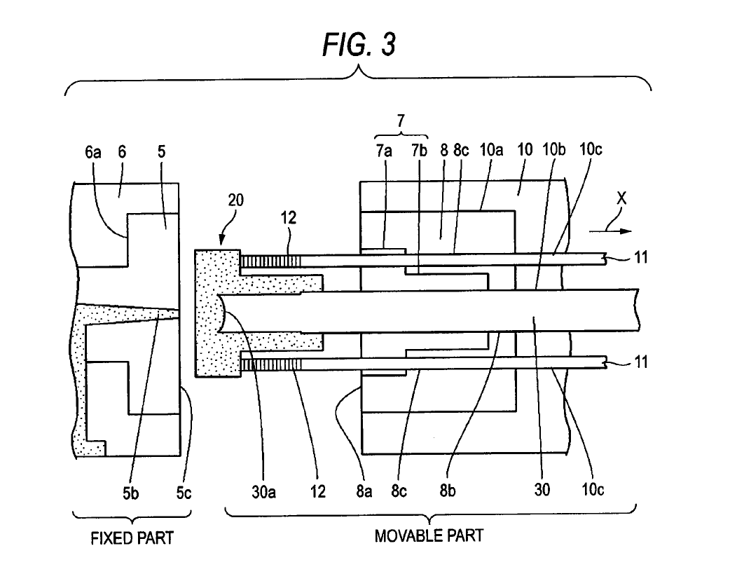

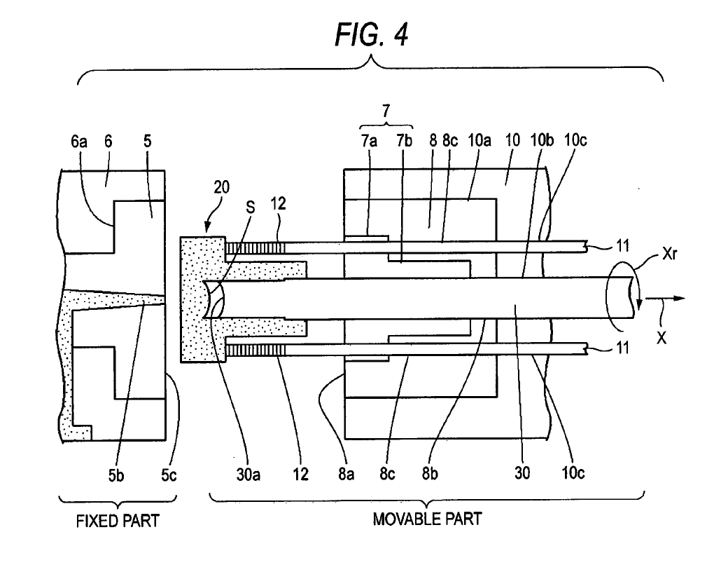

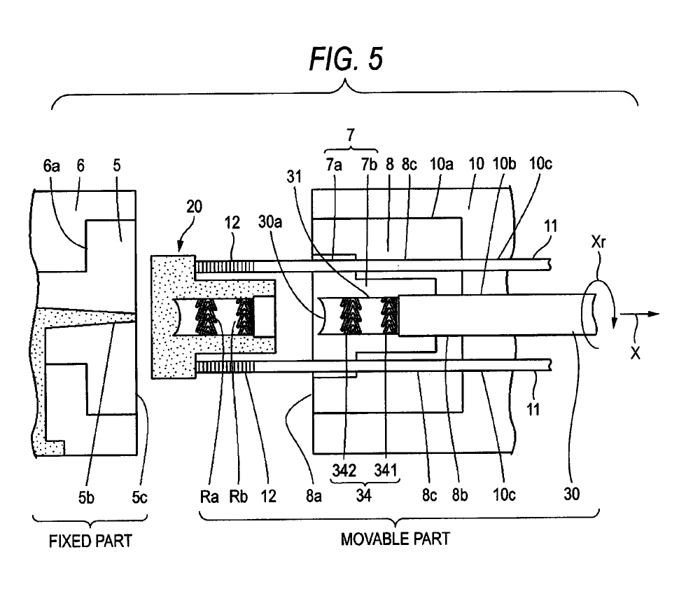

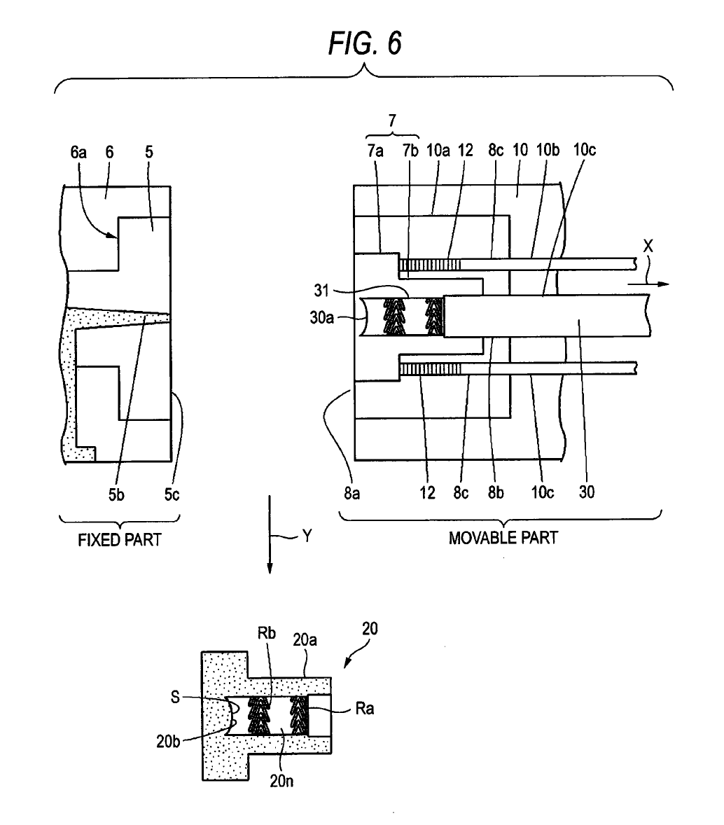

FIG. 1 is a cross-sectional view of an example of an injection molding die composed of a fixed part die and a movable part die for injection-molding the dynamic pressure bearing member according to an embodiment and shown in a condition in which the both are fastened to each other. FIG. 2 is a cross-sectional view showing a condition in which the injection molding die shown in FIG. 1 is opened. FIG. 3 is a cross-sectional view showing a condition in which the cured dynamic pressure bearing member is demolded from a parting surface of the fixed part die, and shows an action following the action shown in FIG. 2. FIG. 4 is a cross-sectional view showing a moment at which a core pin of the movable part die and the dynamic pressure bearing member are separated from each other in a forced pullout manner, and shows an action following the action shown in FIG. 3. FIG. 5 is a cross-sectional view showing a condition in which the core pin of the movable part die and the dynamic pressure bearing member are completely separated from each other in a forced pullout manner, and shows an action following the action shown in FIG. 4. FIG. 6 is a cross-sectional view showing the relationship between the dynamic pressure bearing member in the condition of being obtained by the method of manufacturing a dynamic pressure bearing member according to the embodiment and the injection molding die, and shows an action following FIG. 5.

It should be noted that in the injection molding die according to the embodiment shown in FIG. 1, there are shown only a fixed part die 5 and a fixed part die holder 6 in the fixed part, and only a movable part die 8, a core pin 30, a movable part die holder 10, an ejector pin 11, and a coil spring 12 attached to the tip of the ejector pin 11 in the movable part, and components not directly related to the manufacturing method of a dynamic pressure bearing member according to the embodiment are omitted from the drawing to show it as a principle diagram. The same applies to FIGS. 2 through 6.

Firstly, an example of a configuration of the injection molding die used for manufacturing the dynamic pressure bearing member according to the embodiment will be explained with reference to FIG. 1.

The fixed part of the injection molding die is configured including the fixed part die 5 and the fixed part die holder 6 for holding the fixed part die 5, and the fixed part die 5 is provided with an injection gate 5b for injecting molten resin formed adjacent to the side of the parting surface 5c. The movable part is configured including the movable part die 8, the movable part die holder 10 for holding the movable part die 8, a plurality of ejector pins 11, the coil springs 12 attached to the tips (the side of the cavity 7) of the ejector pins 11, and the single core pin 30. The movable part die 8 is provided with a parting surface 8a capable of adhering to the parting surface 5c of the fixed part die 5, the cavity 7 opening in the parting surface 8a around the gate 5b, a plurality of through holes 8b, 8c with a circular cross-section reaching the cavity 7. The movable part die holder 10 is provided with a recess 10a in which the movable part die 8 can be fitted, and a through hole 10b and a plurality of through holes 10c formed so as to have the same diameters as and the axes in alignment with the through holes 8b, 8c of the movable part die 8, respectively.

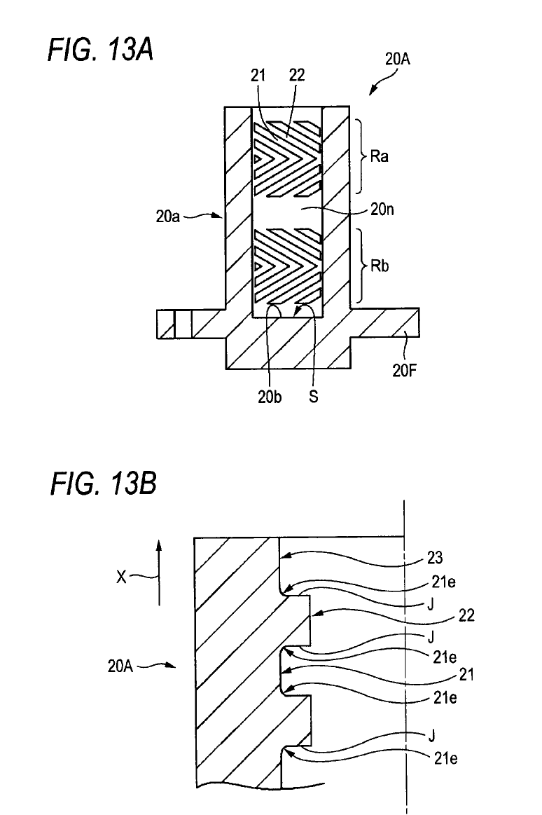

The cavity 7 provided to the movable part die 8 is composed of a bottom section cavity 7a corresponding to a cylindrical section bottom surface 20b (FIG. 6) of the dynamic pressure bearing member 20 to be molded and a cylindrical section cavity 7b corresponding to a cylindrical section 20a (FIG. 6) of the dynamic pressure bearing member 20 similarly to what is shown in FIGS. 13A and 13B.

As shown in FIGS. 5 and 6, the structure of the core pin 30 is as described below. An end portion 30a thereof is formed to be a partial spherical concave curve so that a thrust bearing section S having a partial spherical convex shape in the center section of the inner surface of the cylindrical section bottom surface 20b of the dynamic pressure bearing member 20, and a radial dynamic pressure bearing forming section 34 composed of protruding stripes 341, 342 corresponding to a dynamic pressure grooves Ra, Rb is formed on the outer peripheral surface 31 of the end portion of the core pin 30 so that the dynamic pressure grooves Ra, Rb are formed in two columns in the vertical direction in parallel to each other with a predetermined distance on the inner peripheral surface 20n (FIG. 13A) of the cylindrical section 20a of the dynamic pressure bearing member 20. The protruding stripes 341, 342 are composed of a series of V-shaped protrusions in the cross-section, wherein the V-shaped protrusions are formed so as to have completely the same sizes, angles, pitches, groove widths, and groove depths. Therefore, by using the core pin 30 having such a structure, it is possible to simultaneously form the thrust bearing section S and the radial dynamic pressure grooves Ra, Rb composed of the dynamic pressure grooves 21 and the land sections 22 on the inner surface of the dynamic pressure bearing member 20. Further, the core pin 30 is attached so as to smoothly slide inside the through hole 8b of the movable part die 8 and through hole 10b of the movable part die holder 10.

A plurality of ejector pins 11 is evenly provided for every cavity 7, and the plurality of ejector pins 11 is moved simultaneously, and further, each ejector pin 11 is provided with a coil spring 12 attached to the end section thereof. Further, it is configured that the end section of each of the coil springs 12 remains in a position adjacent to the cylindrical section cavity 7b to form a plane therewith, and never enters the cylindrical section cavity 7b when ejecting and injecting the molten resin. Further, these ejector pins 11 are attached so as to smoothly slide inside the through hole 8c of the movable part die 8 and through hole 10c of the movable part die holder 10.

It is configured that the movable part die 8 can be moved with the movable part die holder 10, and the core pin 30 and all of the ejector pins 11 can be moved independently from each other in the horizontal direction denoted with a symbol X, wherein the core pin 30 is linked with a drive mechanism not shown so as to be slightly rotated as denoted with a symbol Xr according to needs.

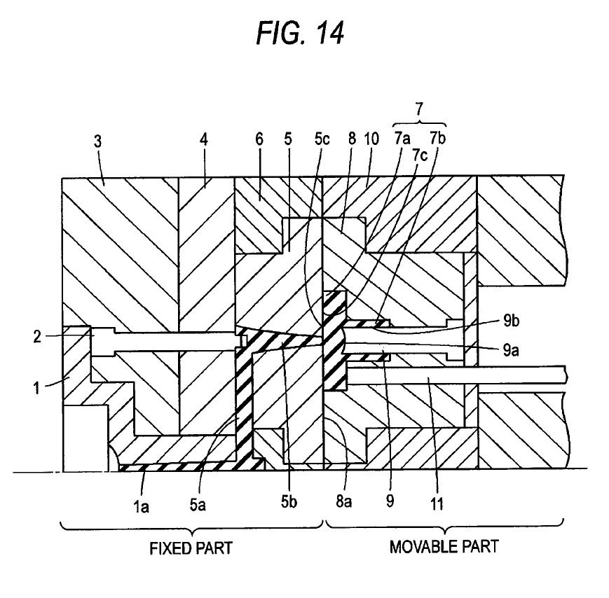

It should be noted that, although the cavity 7 is shown as an example in which the whole of the cavity 7 is formed in the movable part die 8, a part of the cylindrical section cavity 7b can be formed on the parting surface 5c of the fixed part die 5 as the injection molding die in the related art shown in FIG. 14.

A method of manufacturing a dynamic pressure bearing member according to an embodiment will hereinafter be explained with reference to FIGS. 1 through 6.

Firstly, as shown in FIG. 1, the fixed part die 5 is attached to the recess of the fixed part die holder 6, the movable part die 8 is attached to the recess 10a of the movable part die holder 10, the core pin 30 is inserted in the through hole 8b of the movable part die 8 and the through hole 10b of the movable part die holder 10 disposed in alignment with the through hole 8b, the end section 30a thereof is kept in a predetermined position in the middle of the bottom section cavity 7a, further, each of the ejector pins 11 is inserted straight in the through hole 8c of the movable part die 8 and the through hole 10c of the movable part die holder 10, the movable part die 8 is moved in the horizontal direction of the arrow X (X axis) in the drawing so that the parting surface 8a of the movable part die 8 abuts on and adheres to the parting surface 5c of the fixed part die 5 while keeping the end of the coil spring 12 attached to each of the ejector pins 11 in the position adjacent to the cylindrical section cavity 7b to form a plane therewith, the parting surface 8a is fastened to the parting surface 5c, and the molten resin is injected from the molten resin gate 5b and filled in the cavity 7 formed of the fixed part die 5 and the movable part die 8 (FIG. 1).

Subsequently, after the molten resin thus injected and filled therein has been cured, as shown in FIG. 2, fastening of the fixed part die 5 and the movable part die 8 is released, and firstly, only the movable part die 8 and the movable part die holder 10 are together moved backward from the parting surface 5c of the fixed part die 5 and the outer peripheral surface of the dynamic pressure bearing member 20 thus cured and molded in the right direction of the arrow X. In this case, the dynamic pressure bearing member 20 is still in a condition of being pressed against the parting surface 5c of the fixed part die 5 by the ejector pins 11 and the coil springs 12. Further, the core pin 30 does not also move. As apparent from the drawing, the movable part die 8 does not exist around the outer periphery of the dynamic pressure bearing member 20 thus molded to provide a free space.

After then, as shown in FIG. 3, the whole of the movable part is slightly further moved backward to separate the dynamic pressure bearing member 20 from the gate 5b and the parting surface 5c of the fixed part die 5.

Subsequently, as shown in FIG. 4, while keeping the ejector pins 11 and the coil springs 12 in the condition shown in FIG. 3, forced pullout of only the core pin 30 from the inside of the dynamic pressure bearing member 20 in the right direction indicated by the symbol X using the drive mechanism not shown in the drawings is started in the condition in which the movable part die 8 does not exist around the dynamic pressure bearing member 20 thus molded. In this case, since the free space is provided around the outer periphery of the dynamic pressure bearing member 20, even if the land section L of the core pin 30 runs on the land section 22 formed on the inner peripheral surface of the cylindrical section 20a of the dynamic pressure bearing member 20, the dynamic pressure bearing member 20 can evenly be expanded in the radial direction, and accordingly, no damage and no deformation are caused in the radial dynamic pressure grooves Ra, Rb formed of the land sections 22.

Then, by further operating the drive mechanism, as shown in FIG. 5, the core pin 30 is moved right along the X axis to complete the forced pullout from the dynamic pressure bearing member 20, and further the core pin 30 is moved backward into the movable part die 8.

Subsequently, as shown in FIG. 6, when the ejector pins 11 and the coil springs 12 are moved right along the X axis indicated by the symbol X, the dynamic pressure bearing member 20 is separated from the parting surface 5c of the fixed part die 5 and drops (symbol Y).

While going through the molding process as described above, the dynamic pressure bearing member 20 provided with the thrust bearing S formed on the bottom surface 20b with a circular cross-section and the radial dynamic pressure grooves Ra, Rb composed of a series of V-shaped dynamic pressure grooves 21 formed on the inner peripheral surface 20n of the cylindrical section 20a in the inner peripheral direction in two columns in parallel to each other with a predetermined distance as shown in FIG. 6 can be manufactured by injection molding.

Another method of manufacturing a dynamic pressure bearing member according to the embodiment will hereinafter be explained with reference to FIGS. 3 through 8. It should be noted that the processes shown in FIGS. 1 through 3 are common, and accordingly, the explanations therefor will be omitted here.

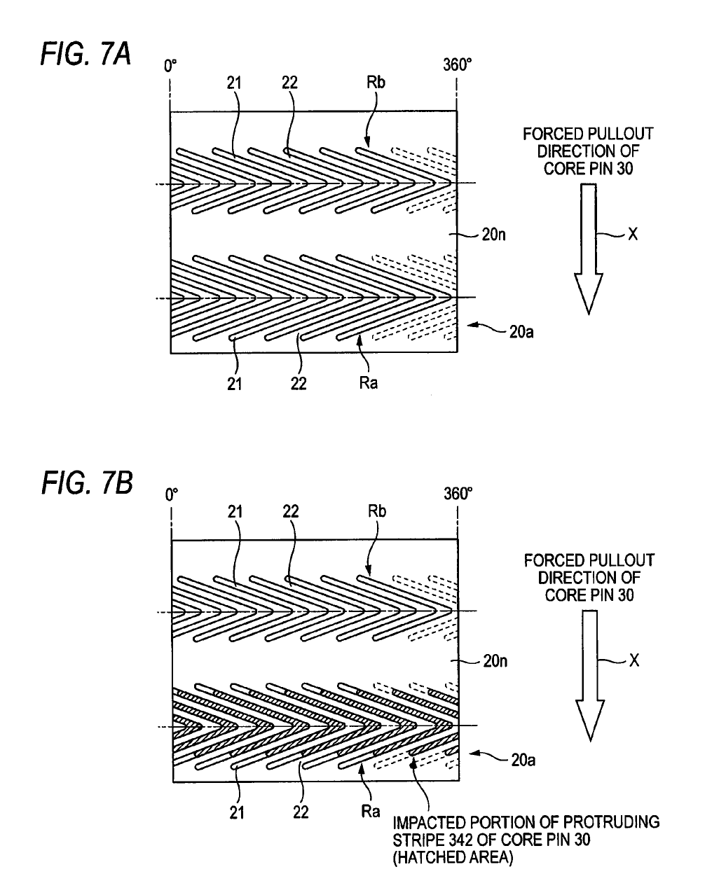

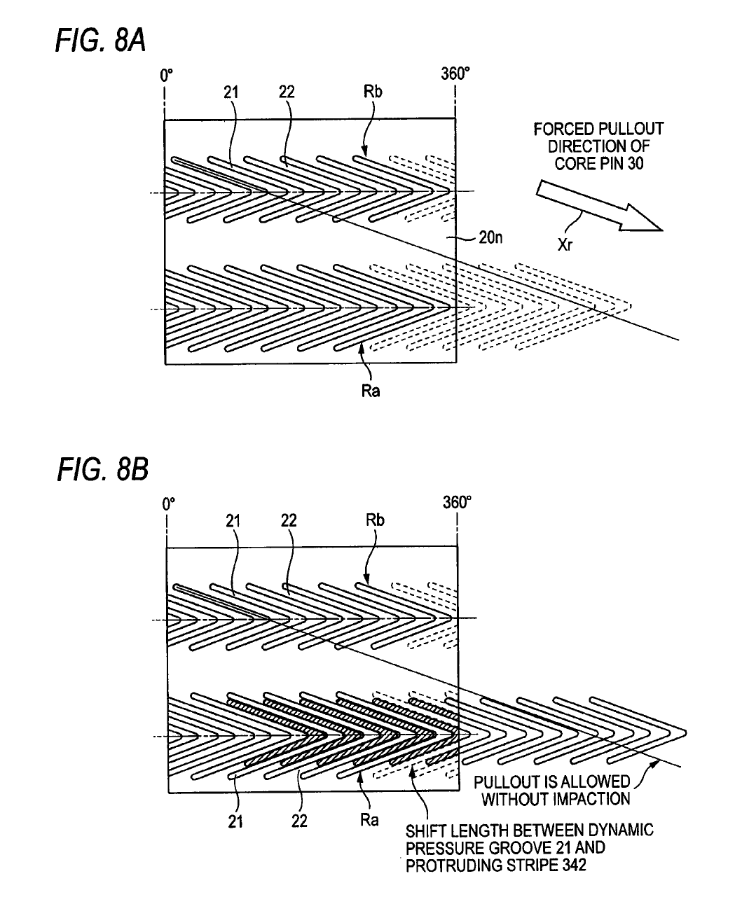

FIGS. 7A and 7B are explanatory views of the case of pulling out the core pin in a forced pullout manner only in the axial direction (the X axis direction) of the dynamic pressure bearing member, wherein FIG. 7A is a development of radial dynamic pressure grooves formed on the inner peripheral surface of the dynamic pressure bearing member, and FIG. 7B is a development obtained by overlapping a development of protruding stripes formed on the outer peripheral surface of the core pin with the development of the radial dynamic pressure grooves of FIG. 7A. FIGS. 8A and 8B are explanatory views of the case of pulling out the core pin in a forced pullout manner in the axial direction of the dynamic pressure bearing member while slightly rotating the core pin, wherein FIG. 8A is the development of radial dynamic pressure grooves formed on the inner peripheral surface of the dynamic pressure bearing member, and FIG. 8B is the development obtained by overlapping the development of protruding stripes formed on the outer peripheral surface of the core pin with the development of the radial dynamic pressure grooves of FIG. 8A.

In the method of manufacturing a dynamic pressure bearing member according to the embodiment described above, when performing the forced pullout of the core pin 30 from the dynamic pressure bearing member 20, the core pin 30 is rotated with a small rotational angle of less than one revolution from the condition shown in FIG. 3 to the condition shown in FIG. 5 as indicated by the symbol Xr in FIGS. 4 and 5, thus pulling out from the molded dynamic pressure bearing member 20 in a forced pullout manner in the X axis direction.

If the rotation of the core pin 30 as described above is not performed, the protruding stripes 342 out of the protruding stripes 341, 342 of the core pin 30, which have pulled out once in a forced pullout manner, might drop in the radial dynamic pressure grooves Ra. Specifically, it is assumed that, for example, in the radial dynamic pressure bearing forming section 34 composed of the two columns of V-shaped protruding stripes 341, 342 formed on the outer peripheral surface 31 of the core pin 30 shown in FIGS. 5 and 6, in the case in which two columns of dynamic pressure grooves Ra, Rb having completely the same size, angle, pitch, groove width, groove depth and so on of the V-shape are formed on the inner peripheral surface of the cylindrical section 20a of the dynamic pressure bearing member 20 as shown in FIGS. 5, 6, and 13, the core pin 30 is pulled out from the dynamic pressure bearing member 20 in a forced pullout manner.

It should be noted that FIGS. 7A and 8A are developments showing the radial dynamic pressure grooves Ra, Rb composed of the two columns of the dynamic pressure grooves 21 and the land sections 22 formed on the inner peripheral surface 20n of the cylindrical section 20a of the dynamic pressure bearing member 20 by developing throughout the entire peripheral surface of 360°, wherein it is assumed that the radial dynamic pressure grooves Ra are formed with a width (width of the V-shape) greater than the width of the radial dynamic pressure grooves Rb.

In such a case, if the forced pullout of the core pin 30 from the dynamic pressure bearing member 20 only in the X direction indicated by the symbol X is performed, the protruding stripes 341, 342 of the core pin 30 are respectively pulled out from the radial dynamic pressure grooves Ra, Rb, and subsequently, the protruding stripes 342, which have formed the radial dynamic pressure grooves Rb, drop in the respective dynamic pressure grooves 21 of the radial dynamic pressure grooves Ra as shown in FIG. 7B with hatching. Then, it is not until the forced pullout is further performed, that the core pin 30 can completely be pulled out from the dynamic pressure bearing member 20.

As is apparent from the forced pullout condition described above, the radial dynamic pressure grooves Ra are processed with the forced pullout with the protruding stripes 342 and 341 in series, accordingly, the radial dynamic pressure grooves Ra might be placed in the condition of being easily injured or deformed depending on the shapes of the protruding stripes 341, 342. It is not preferable for generating preferable fluid dynamic pressure that the radial dynamic pressure grooves Ra are injured or deformed.

Therefore, in the method of manufacturing a dynamic pressure bearing member according to the present embodiment, as shown in FIGS. 4, 5, and 8, the core pin 30 is pulled out in a forced pullout manner from the dynamic pressure bearing member 20 in the X axis direction of the dynamic pressure bearing member 20 indicated by the symbol X while rotating the core pin 30 in a direction towards the extremity of the V-shaped dynamic pressure grooves Ra, Rb indicated by the symbol Xr with a small rotational angle less than one revolution using, for example, a cam-shaft mechanism (not shown). In this case, although at first the protruding stripes 341, 342 of the core pin 30 are pulled out from the radial dynamic pressure grooves Ra, Rb, respectively, the protruding stripes 342 of the core pin 30 are subsequently shifted from the positions of the dynamic pressure grooves 21 composing the redial dynamic pressure grooves Ra as shown in FIG. 8B, and accordingly, the core pin 30 can be pulled out in a forced pullout manner from the dynamic pressure bearing member 20 without dropping in the grooves.

Therefore, the forced pullout of the core pin 30 from the dynamic pressure bearing member 20 can be performed without substantial scratches or deformation of the radial dynamic pressure grooves Ra.

Although in the explanations of the first embodiment and the second embodiment, the descriptions that the core pin 30 is pulled out in a forced pullout manner from the molded dynamic pressure bearing member 20 are used, it will easily be understood that the injection molding die can reversely be configured so as to pull out the dynamic pressure bearing member 20 from the core pin 30 in a forced pullout manner, and that the same functions and advantages can be obtained.

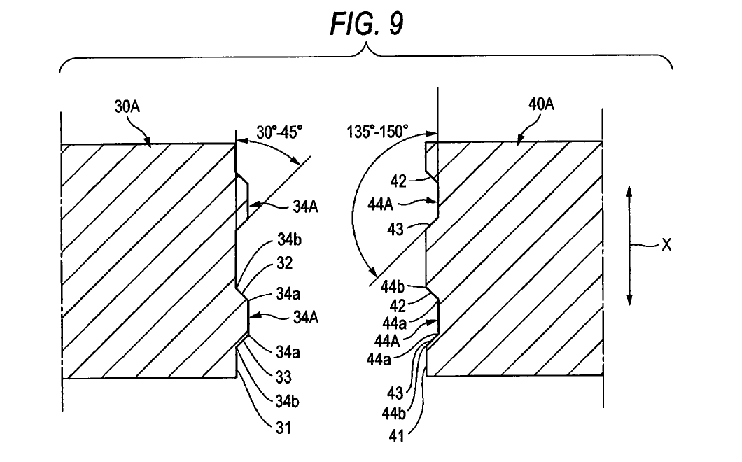

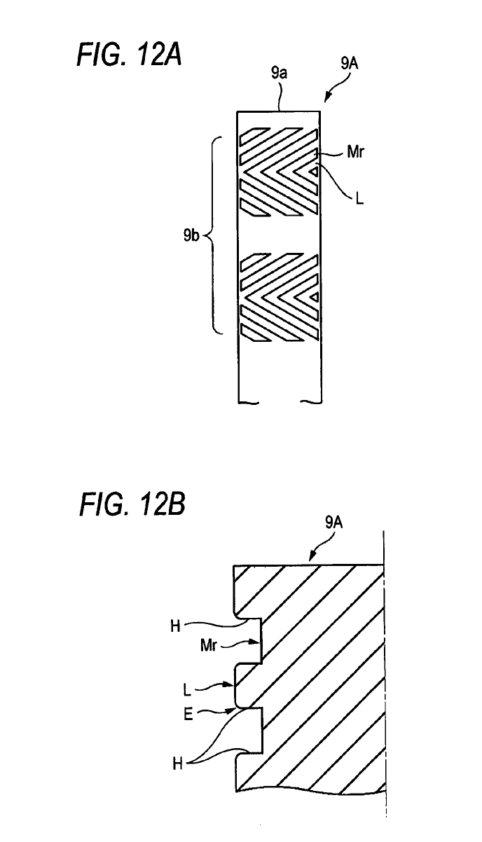

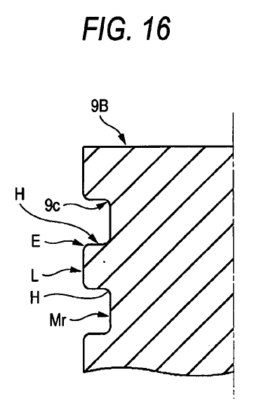

It is preferable that, in the forced pullout of the core pin 30, the forced pullout of the core pin 30 is performed with as small deformation of the radial dynamic pressure grooves Ra, Rb of the dynamic pressure bearing member 20 as possible. Regarding the shapes and the structure of the protruding stripes 341, 342 of the core pin 30, although the core pin 9A as shown in FIGS. 12A and 12B or the core pin 9B as shown in FIG. 16 can be used, it is preferable to use core pins as shown in FIGS. 9 through 11 in order for forming the dynamic pressure bearing member 20 with much smaller deformation of the dynamic pressure grooves Ra, Rb.

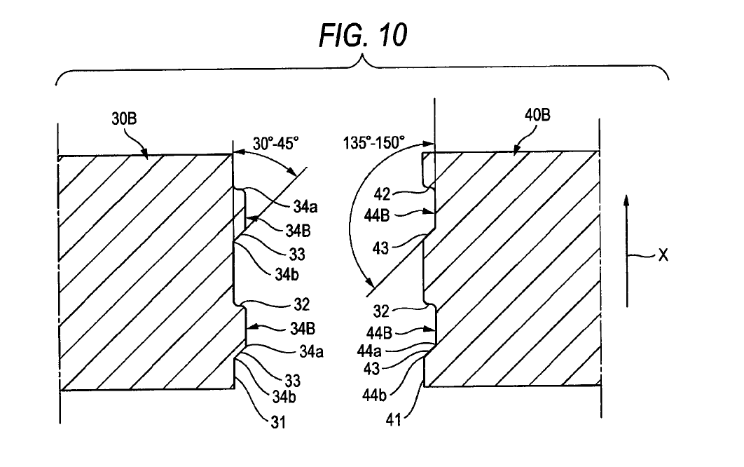

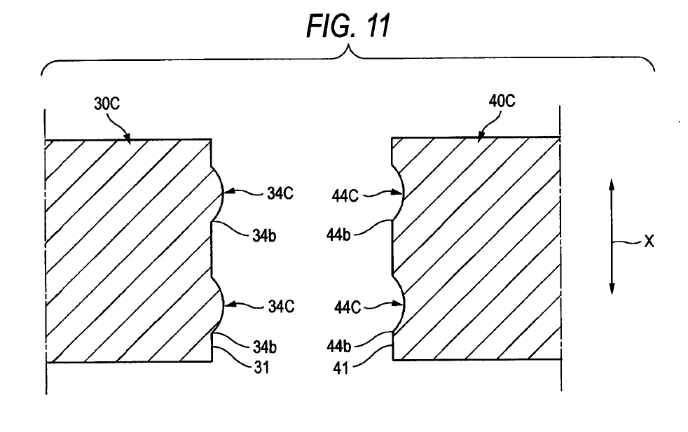

FIG. 9 is a cross-sectional view showing a part of the core pin with a first shape preferably used for an embodiment and a part of the dynamic pressure bearing member with a first shape molded with the present core pin. FIG. 10 is a cross-sectional view showing a part of the core pin with a second shape preferably used for the embodiment and a part of the dynamic pressure bearing member with a second shape molded with the present core pin. Further, FIG. 11 is a cross-sectional view showing a part of the core pin with a third shape preferably used for the embodiment and a part of the dynamic pressure bearing member with a third shape molded with the present core pin.

The core pin 30A with the first shape shown in FIG. 9 is provided with trapezoidal protruding stripes 34A formed on the outer peripheral surface 31, which are for forming dynamic pressure grooves 44A described later, and have the cross-sections each including a front slope 32 and a rear slope 33 having symmetrical tilt angles. It is a metal mold die in which the tilt angles of the front slope 32 and the rear slope 33 in the forced pullout direction indicated by the arrow X in these trapezoidal protruding stripes 34A with respect to the outer peripheral surface 31 of the core pin 30A are formed to be in a range of 30° through 45°, and surface corners 34a of the trapezoidal protruding stripes 34A and bottom corners 34b of the trapezoidal protruding stripes 34A are chamfered or formed to be substantially round corners.

When such a core pin 30A is inserted in the center section of the movable part die 8 shown in FIG. 1 to form the cavity 7, and molten resin is injected into the cavity 7 from the gate 5b, the trapezoidal concave dynamic pressure grooves 44A with the shape corresponding to the trapezoidal protruding stripes 34A are formed on the inner peripheral surface 41 of a cylinder, which will form a dynamic pressure bearing member 40A, by transfer.

Specifically, the dynamic pressure bearing member 40A is provided with a series of V-shaped grooves continuously formed on the entire inner peripheral surface of the cylindrical section in the circumferential direction by injection molding to form the radial bearing surface. These trapezoidal concave dynamic pressure grooves 44A are each provided with a tilted front slope 42 and a rear slope 43 instead of surfaces perpendicular to the forced pullout direction X in the case in which the trapezoidal protruding stripes 34A are pulled out from the dynamic pressure bearing member 40A in a forced pullout manner using the method according to the embodiment. The tilt angle of the rear slope 43 is formed in a range from 135° to 150°. The tilt angle of the front slope 42 is formed to be symmetrical to the tilt angle of the rear slope 43. Further, bottom corner sections 44a and opening corner sections 44b of the trapezoidal concave dynamic pressure grooves 44A are chamfered or formed to be substantially round corners.

As described above, since the dynamic pressure bearing member 40A with the present shape is composed of the trapezoidal concave dynamic pressure grooves 44A each having a cross-section including the front slope 42 and the rear slope 43 with the tilt angles symmetrical to each other, the dynamic pressure bearing member 40A can easily be pulled out in a forced pullout manner from the core pin 30 with the present shape in either directions of the arrow X.

A core pin 30B with a second shape and a dynamic pressure bearing member 40B with a second shape molded with the core pin 30B will now be explained with reference to FIG. 10. Each of them is shown as a partial cross-sectional view similarly to the case with FIG. 9.

The core pin 30B is provided with asymmetrical trapezoidal protruding stripes 34B formed on the outer peripheral surface 31 thereof, which are for forming trapezoidal concave dynamic pressure grooves 44B of the dynamic pressure bearing member 40B with the present shape described later, and have cross-sections each including a front slope 32 rising substantially perpendicular to the outer peripheral surface 31 of the core pin 30B and a rear slope 33 having the same tilt angle with the rear slope 33 of the trapezoidal protruding stripes 34A with the first shape. It is a metal mold die in which the tilt angle of the rear slope 33 in the forced pullout direction indicated by the arrow X in these trapezoidal protruding stripes 34B with respect to the outer peripheral surface 31 of the core pin 30B is formed to be in a range of 30° through 45°, and surface corners 34a of the trapezoidal protruding stripes 34B and bottom corners 34b of the trapezoidal protruding stripes 34B are chamfered or formed to be substantially round corners.

When such a core pin 30B is inserted in the center through hole 8b of the movable part die 8 shown in FIG. 1 to form the cavity 7, and molten resin is injected into the cavity 7 from the gate 5b, the trapezoidal concave dynamic pressure grooves 44B with the shape corresponding to the trapezoidal protruding stripes 34B are formed on the inner peripheral surface 41 of a cylinder, which will form a dynamic pressure bearing member 40B, by transfer.

Specifically, the dynamic pressure bearing member 40B is provided with a series of V-shaped grooves each having a cross-section composed of the trapezoidal concave dynamic pressure grooves 44B continuously formed on the entire inner peripheral surface 41 of the resin cylinder in the circumferential direction by injection molding to form the radial bearing surface. These trapezoidal concave dynamic pressure grooves 44B are each provided with a tilted rear slope 43 instead of a surface perpendicular to the forced pullout direction X so that the forced pullout can easily be performed in the case in which the trapezoidal protruding stripes 34B are pulled out from the dynamic pressure bearing member 40B in a forced pullout manner. The tilt angle of the rear slope 43 is formed in a range from 135° to 145°. Since the tilt angle of the front slope 32 is steeper than the tilt angle of the rear slope 33, it does not become the forced pullout direction. Further, bottom corner sections 44a and opening corner sections 44b of the trapezoidal concave dynamic pressure grooves 44B are chamfered or formed to be substantially round corners.

As described above, since the dynamic pressure bearing member 40B of the present shape is composed of the trapezoidal concave dynamic pressure grooves 44B each having the cross-section including the front slope 32 and the rear slope 33 with asymmetrical angles, although the forced pullout from the core pin 30B with the present shape is limited to one direction of arrow X, the forced pullout from the core pin 30B can easily be performed similarly to the dynamic pressure bearing member 40A with the first shape.

A core pin 30C with a third shape and a resin dynamic pressure bearing 40C with a third shape molded with the core pin 30C will now be explained with reference to FIG. 11. Each of them is shown as a partial cross-sectional view similarly to the case with FIGS. 9 and 10.

The core pin 30C with a present shape is provided with partial circular protruding stripes 34C formed on the outer peripheral surface 31, which are for forming dynamic pressure grooves 44C each having a partial circular concave cross-section and formed on the inner peripheral surface 41 of the dynamic pressure bearing 40C with the present shape described later, and have cross-sections each including a partial circular arc with respect to the outer peripheral surface 31 of the core pin 30C. It is a metal mold diein which the partial circular protruding stripes 34C allow the dynamic pressure bearing 40C to be pulled out in a forced pullout manner in either directions of the axial direction indicated with the arrow X, and the base section 34b of the partial circular protruding stripes 34C are chamfered or formed to be substantially round corners.

When such a core pin 30C is inserted in the center section of the movable part die 8 shown in FIG. 1 to form the cavity 7, and molten resin is injected into the cavity 7 from the gate 5b, the dynamic pressure grooves 44C having shapes corresponding to the partial circular protruding stripes 34C and the partial circular cross-sections are formed on the inner peripheral surface 41 of a cylinder, which will form a dynamic pressure bearing 40C, by transfer. The opening corner sections 44b of the partial circular dynamic pressure grooves 44C are chamfered or formed to be substantially round corners.

It is desirable to form the dynamic pressure grooves 44A, 44B, and 44C of the respective dynamic pressure bearing members 40A, 40B, and 40C of either shapes with the V-shape grooves, and the dynamic pressure bearing members 40A, 40B, and 40C are configured by forming the V-shaped grooves in series on the respective one of the entire inner peripheral surfaces 41.

Further, it is desirable that the dynamic pressure grooves 44A, 44B, and 44C are each formed as a series of grooves in two or more columns disposed in the axial direction with a predetermined interval.

In the manufacturing method for forming the dynamic pressure grooves 44A, 44B, or 44C on the inner peripheral surface 41 of the dynamic pressure bearing member 40A, 40B, or 40C by injection molding using either one of the core pins 30A, 30B, and 30C, the core pin 30A, 30B, or 30C is provided with the trapezoidal protruding stripes 34A or 34B, or the partial circular protruding stripes 34C formed with the slope 42 or 43, or the partial circular surface towards the forced pullout direction F, and the surface corner sections 34a of the respective trapezoidal protruding stripes 34A and 34B and the base sections 34b of the respective trapezoidal protruding stripes 34B are chamfered or formed as substantially round corners, and the base sections 34b of the partial circular protruding stripes 34C of the core pin 30C with the third shape are chamfered or formed as substantially round corners. Therefore, in the case in which the molten resin is injected in the cavity 7 provided with the core pin 30A, 30B, or 30C inserted therein to mold, and then the dynamic pressure bearing member 40A, 40B, or 40C is pulled out in a forced pullout manner after molding, the forced pullout force is weakened by surface sliding between the core pin 30A, 30B, or 30C and the dynamic pressure bearing member 40A, 40B, or 40C, thus preventing the molded dynamic pressure bearing member 40A, 40B, or 40C from being injured.

In one example of dimensions of the dynamic pressure bearing members 20, 40A, 40B, and 40C: the outside diameter of the cylindrical section 20a is 6 mm; inside diameter thereof is 3mm; the entire length of the dynamic pressure bearing member 20 is 8.6 mm; the length of the cylindrical section 20a is 4.7 mm; the width of the dynamic pressure grooves Ra, Rb is 1 mm through 1.5 mm; the distance between the dynamic pressure grooves Ra and Rb is about 0.6 mm; the width of the each of the V-shaped grooves of the dynamic pressure grooves Ra, Rb is about 50 μm; the depth of the grooves is about 2 μm through 12 μm.

It is necessary to use a material with elasticity as high as possible as a typical resin used for the resin dynamic pressure bearing member in order for achieving the dimensional accuracy and the rigidity required for the bearing member.

However, in the dynamic pressure bearing member according to the embodiment, as described above, the free space is provided around the outer periphery of the molded dynamic pressure bearing member 20 when performing the forced pullout of the core pin 30, and further, the slope is provided to the rear surface of the recess of the dynamic pressure grooves with respect to the forced pullout direction X of the core pin 30, thus the dynamic pressure bearing member according to the embodiment can easily be pulled out in a forced pullout manner from the core pin 30 after molding. Therefore, materials with high rigidity can also be used therefor. As examples thereof, in addition to polyetheretherketone resin, polyphenylenesulphide resin, polybutyleneterephthalate resin, and polyethyleneterephthalate resin, and so on can be cited.

Further, it should be noted that although a typical outer shape of the dynamic pressure bearing member 20, 40A, 40B, or 40C is a cylinder, it is not limited to a cylinder in the embodiment, but can be molded as, for example, a shape with a square cross-section, in accordance with the mounting location of the dynamic pressure bearing member.

Applications include, for example, the electronic motor industry, the bearing manufacturing industry, and the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of manufacturing a dynamic pressure bearing member, by providing a metal mold die including a core pin provided with protruding stripes of a predetermined shape formed on an outer peripheral surface for forming dynamic pressure grooves, and injecting molten resin in the metal mold die to form at least a series of dynamic pressure grooves on an inner peripheral surface with a circular cross-section in an inner circumferential direction, comprising:
pulling out in a forced pullout manner one of the core pin from the dynamic pressure bearing member or the dynamic pressure bearing member from the core pin in an axial direction of the dynamic pressure bearing member after curing the molten resin, in a condition in which a free space is provided around an outer periphery of the molded dynamic pressure bearing member.

2. The method of manufacturing a dynamic pressure bearing member according to claim 1,
wherein corners of the protruding stripes formed on the outer peripheral surface of the core pin are chamfered.

3. The method of manufacturing a dynamic pressure bearing member according to claim 1,
wherein the protruding stripes are formed so that a shape of a cross-section of each of the protruding stripes formed on the outer peripheral surface of the core pin forms an acute angle with the reference of the outer peripheral surface of the core pin to a direction of the forced pullout of the dynamic pressure bearing member, and the acute angle is in a range of 30° through 45°.

4. The method of manufacturing a dynamic pressure bearing member according to claim 1,
wherein the cross-sectional shapes corresponding to the shapes of the dynamic pressure grooves are formed on the outer peripheral surface of the core pin as trapezoidal protruding stripes, a tilt angle of at least a rear slope of the trapezoidal protruding stripes in the forced pullout direction is formed as an acute angle with the reference of the outer peripheral surface of the core pin, the acute angle is formed in a range of 30° through 45°, and the surface corner sections of each of the trapezoidal protruding stripes and the base sections of each of the trapezoidal protruding stripes are chamfered or formed as substantially round corners.

5. The method of manufacturing a dynamic pressure bearing member according to claim 1,
wherein the cross-sectional shapes corresponding to the shapes of the dynamic pressure grooves are formed on the outer peripheral surface of the core pin as partial circular protruding stripes, the base sections of each of the partial circular protruding stripes are chamfered or formed as substantially round corners.

6. The method of manufacturing a dynamic pressure bearing member according to claim 1,
wherein the core pin is rotated, and the core pin is pulled out in a forced pullout manner in the axial direction of the dynamic pressure bearing member in the condition in which the free space is provided around the dynamic pressure bearing member.

7. A method of manufacturing a dynamic pressure bearing member provided with at least a series of dynamic pressure grooves formed on an inner peripheral surface with a circular cross-section in the inner circumferential direction by injection molding, comprising:
providing an injection molding die including
a fixed part die provided with a molten resin injection gate formed adjacent to a parting surface,
a movable part die provided with a parting surface capable of adhering to the parting surface of the fixed part die, a through hole with a circular cross-section penetrating to the parting surface, and a cavity forming at least a part of the dynamic pressure bearing member to be formed, and
a core pin having a thickness capable of being inserted in the through hole of the movable part die, facing at least the cavity, and provided with protruding stripes of predetermined shapes formed on the outer peripheral surface, for forming the dynamic pressure grooves;
fastening the parting surface of the movable part die to the parting surface of the fixed part die after abutting the parting surface of the movable part die on the parting surface of the fixed part die and adhering the parting surface of the movable part die to the parting surface of the fixed part die in the condition in which the core pin is inserted to a predetermined position of the through hole of the movable part die;
filling the cavity formed of the fixed part die and the movable part die with the molten resin by injecting the molten resin into the cavity from the molten resin injection gate;
releasing the fastening between the fixed part die and the movable part die after the injected and filled molten resin has been cured;
moving the movable part die backward from the parting surface of the fixed part die and an outer peripheral surface of the cured dynamic pressure bearing member; and
subsequently pulling out in a forced pullout manner one of the core pin from the dynamic pressure bearing member or the dynamic pressure bearing member in an axial direction of the dynamic pressure bearing member, in a condition in which the movable part die does not exist around the dynamic pressure bearing member.

8. The method of manufacturing a dynamic pressure bearing member according to claim 7,
wherein the protruding stripes on the outer peripheral surface of the core pin are formed in two or more columns with a predetermined interval in the axial direction of the core pin.

9. The method of manufacturing a dynamic pressure bearing member according to claim 8,
wherein the protruding stripes on the outer peripheral surface of the core pin are V-shaped protrusions provided in series.

10. The method of manufacturing a dynamic pressure bearing member according to claim 9,
wherein the core pin is rotated, and the core pin is pulled out in a forced pullout manner in the axial direction of the dynamic pressure bearing member in the condition in which the free space is provided around the dynamic pressure bearing member.

11. The method of manufacturing a dynamic pressure bearing member according to claim 10,
wherein the rotational direction of the core pin is a direction towards the extremity of the V-shaped protruding stripes.

12. The method of manufacturing a dynamic pressure bearing member according to claim 11,
wherein in the case in which the core pin is pulled out in a forced pullout manner in the axial direction of the dynamic pressure bearing member provided with the dynamic pressure grooves formed on the inner peripheral surface of the cylindrical section in two or more columns,
the rotational angle of the core pin excludes an angle with which the series of protruding stripes drop in the adjacent dynamic pressure grooves in the axial direction in which the core pin is pulled out in a forced pullout manner.

13. The method of manufacturing a dynamic pressure bearing member according to claim 9,
wherein corners of the protruding stripes formed on the outer peripheral surface of the core pin are chamfered.

14. The method of manufacturing a dynamic pressure bearing member according to claim 9,
wherein the protruding stripes are formed so that a shape of a cross-section of each of the protruding stripes formed on the outer peripheral surface of the core pin forms an acute angle with the reference of the outer peripheral surface of the core pin to a direction of the forced pullout of the dynamic pressure bearing member, and the acute angle is in a range of 30° through 45°.

15. The method of manufacturing a dynamic pressure bearing member according to claim 9,
wherein the cross-sectional shapes corresponding to the shapes of the dynamic pressure grooves are formed on the outer peripheral surface of the core pin as trapezoidal protruding stripes,
a tilt angle of at least a rear slope of the trapezoidal protruding stripes in the forced pullout direction is formed as an acute angle with the reference of the outer peripheral surface of the core pin, the acute angle is formed in a range of 30° through 45°, and
the surface corner sections of each of the trapezoidal protruding stripes and the base sections of each of the trapezoidal protruding stripes are chamfered or formed as substantially round corners.

16. The method of manufacturing a dynamic pressure bearing member according to claim 9,
wherein the cross-sectional shapes corresponding to the shapes of the dynamic pressure grooves are formed on the outer peripheral surface of the core pin as partial circular protruding stripes, and
the base sections of each of the partial circular protruding stripes are chamfered or formed as substantially round corners.
